(19) United States
(12) Patent Application Publication
(10) Pub. No.: US 2009/0276694 A1
(43) Pub. Date: Nov. 5, 2009

(54) System and Method for Document Display

(75) Inventors: Daniel J. Henry, Troy, MI (US); Michael R. Bascobert, Clarkston, MI (US)

Correspondence Address: Daniel J. Henry, 2980 Townhill, Troy, MI, 48084, US

(73) Assignee: AccuPatent, Inc.

(21) Appl. No.: 12/435,287

(22) Filed: May 4, 2009

Related U.S. Application Data
(63) Continuation-in-part of application No. 12/389,366, filed on Feb. 19, 2009.
Application No. 12/389,366 is a continuation-in-part of application No. 12/193,039, filed on Aug. 17, 2008.
Application No. 12/193,039 is a continuation-in-part of application No. 12/193,039, filed on Aug. 17, 2008.
(60) Provisional application No. 61/049,813, filed on May 2, 2008.
(60) Provisional application No. 61/142,651, filed on Jan. 6, 2009.
(60) Provisional application No. 61/151,506, filed on Feb. 10, 2009.
(60) Provisional application No. 61/049,813, filed on May 2, 2008.

(51) Int. Cl. G06F 17/00; G06F 3/048

(52) U.S. Cl. 715/243; 715/823

(57) ABSTRACT

A computer implemented method for displaying document information includes receiving a document, identifying a plurality of different terms in the document, determining positions of the terms in the document, and creating an index of the terms on the document. The plurality of terms in the index are indexed to the plurality of positions in the document such that selection of any of the terms in the index identifies the selected term in the document

### RELATED APPLICATIONS

The present application is a continuation in part of U.S. patent application Ser. No. 12/389,366, titled “System and Method for Search”, filed Feb. 18, 2009, which in turn claims priority to U.S. patent application Ser. No. 12/193,039, titled “System and Method for Analyzing a Document”, filed Aug. 17, 2008, which in turn claims priority to U.S. Provisional Application Ser. No. 60/956,407, titled “System and Method for Analyzing a Document,” filed on Aug. 17, 2007, and also claims priority to U.S. Provisional Application Ser. No. 61/049,813, titled “System and Method for Analyzing Documents,” filed on May 2, 2008, the present application is also a continuation in part of U.S. patent application Ser. No. 12/193,039, titled “System and Method for Analyzing a Document”, filed Aug. 17, 2008, the present application also claims priority to U.S. Provisional Application Ser. No. 61/142,651, titled “System and Method for Search”, filed Jan. 6, 2009, as well as U.S. Provisional Application Ser. No. 61/151,506, titled “System and Method for Search”, filed Feb. 10, 2009, and also claims priority to U.S. Provisional Application Ser. No. 61/049,813, titled “System and Method for Analyzing Documents,” filed on May 2, 2008, the contents of the above mentioned applications are hereby incorporated by reference in their entirety.

### BACKGROUND

Conventional word processing, typing or creation of complex legal documents, such as patents, commonly utilizes a detailed review to ensure accuracy. Litigators and other analysts that review issued patents many times look for critical information related to those documents for a multitude of purposes.

As discussed herein, the systems and methods provide for document analysis. Systems such as spell checkers and grammar checkers only look to a particular word (in the case of a spell checker) and a sentence (in the case of a grammar checker) and only attempt to identify basic spelling and grammar errors. However, these systems do not provide for checking or verification within the context of an entire document that may also include graphical elements and do not look for more complex errors or to extract particular information.

Conventional document display devices provide text or graphical information related to a document, such as a patent download service. However, such conventional document display devices do not interrelate critical information in such documents to allow correlation of important information across multiple information sources. Moreover, such devices do not interrelate graphical and textual elements.

With respect to programming languages, certain tools are used by compilers and/or interpreters to verify the accuracy of structured-software language code. However, software-language lexers (e.g., a lexical analysis tool) differ from natural language documents (e.g., a document produced for humans) in that lexers use rigid rules for interpreting keywords and structure. Natural language documents such as patent applications or legal briefs are loosely structured when compared to rigid programming language requirements. Thus, strict rule-based application of lexical analysis is not possible. Moreover, current natural language processing (NLP) systems are not capable of document-based analysis.

Moreover, conventional search methods may not provide relevant information. In an example, documents are produced from a search that may include search keywords, but are cluttered through the document, or non-existent. Thus, an improved search method is desired.

### BRIEF DESCRIPTION OF THE DRAWINGS

The present invention will now be described, by way of example, with reference to the accompanying drawings, in which:

FIG. 1 shows a method for generating bookmarks and links within a document.

FIG. 1A is an example of document analysis for improved indexing, searching, and display.

FIG. 1B is an example of a document analysis and markup system.

FIG. 2 shows a system for analyzing and creating documents.

FIG. 3 shows an example of a display.

FIG. 4 shows an example of a display.

FIG. 5 shows an example of a display.

FIG. 6 shows an example of a display.

FIG. 7 shows an example of a display.

FIG. 8 shows an example of a display.

FIG. 9 shows an example of a display.

FIG. 10 shows an example of a display.

FIG. 11 shows an example of a display.

FIG. 12 shows an example of a display.

FIG. 13 shows an example of a display.

FIG. 14 is an example flow diagram for a report generator related to patent documents.

FIG. 15 is an example flow diagram for a report generator related to patent documents.

FIG. 16 is an example of a document retrieval and report generation method.

### DETAILED DESCRIPTION

The present application is a continuation in part of U.S. patent application Ser. No. 12/389,366, titled “System and Method for Search”, filed Feb. 18, 2009, which in turn claims priority to U.S. patent application Ser. No. 12/193,039, titled “System and Method for Analyzing a Document”, filed Aug. 17, 2008, which in turn claims priority to U.S. Provisional Application Ser. No. 60/956,407, titled “System and Method for Analyzing a Document,” filed on Aug. 17, 2007, and also claims priority to U.S. Provisional Application Ser. No. 61/049,813, titled “System and Method for Analyzing Documents,” filed on May 2, 2008, the present application is also a continuation in part of U.S. patent application Ser. No. 12/193,039, titled “System and Method for Analyzing a Document”, filed Aug. 17, 2008, the present application also claims priority to U.S. Provisional Application Ser. No. 61/142,651, titled “System and Method for Search”, filed Jan. 6, 2009, as well as U.S. Provisional Application Ser. No. 61/151,506, titled “System and Method for Search”, filed Feb. 10, 2009, and also claims priority to U.S. Provisional Application Ser. No. 61/049,813, titled “System and Method for Analyzing Documents,” filed on May 2, 2008, the contents of the above mentioned applications are hereby incorporated by reference in their entirety.

Referring now to the drawings, illustrative embodiments are shown in detail. Although the drawings represent the embodiments, the drawings are not necessarily to scale and certain features may be exaggerated to better illustrate and explain an embodiment. Further, the embodiments described herein are not intended to be exhaustive or otherwise limit or restrict the invention to the precise form and configuration shown in the drawings and disclosed in the following detailed description.

In general, documents may be provided with specialized bookmarking and highlighting based on their own content as well as user terms (e.g., search terms). When discussing a patent document, for example, the bookmarking may include the element names and numbers, figure numbers, claim terms, etc. that have bookmarks linked to locations in a document (allowing the user to jump to that location or to highlight it).

For example, a listing of element name/number pairs may be provided (sorted by name and/or number) where each sub-bookmark would include the figure number where that element is used. Each bookmark may the allow navigation to the different document locations associated with that element, for example, the drawings, specification, claims, abstract etc. Alternatively, the figures may be bookmarked and have the elements used in that figure bookmarked in the document. Similarly, each document section may be bookmarked in this way for based on information contained within the document itself (e.g., elements, figures, claim terms, etc.) or using outside information such as user search terms.

Additionally, other information may be bookmarked such as the most relevant section for each element. This section location may be concluded by where the element is introduced initially in the document or where it is discussed more often (e.g., where the element is discussed most often). Similarly, the most relevant drawing may be identified and that bookmarked for the element.

Additionally, search terms (e.g., where the document is identified as a result of a search) may be bookmarked in the document along with other relevant information such as the most relevant drawing to the search term and/or the overall search performed.

In another example, bookmarks may be added for information that appears in one section of a document but not another or other inconsistencies. For example, bookmarks may be added for element name or number inconsistencies (e.g., “connector 10” is used as well as “plug 10”). Moreover, bookmarks may be used to identify words in the claims section that are never used in the specification section. Bookmarks may also indicate that partial claim terms may be used in the specification to guide the user to finding them (e.g., “sealingly” is used in the claims but “sealed” is used in the specification).

In general, a patent PDF may be enhanced by bookmarking useful content. Examples include bookmarking and linking all elements used in the specification (e.g., bookmarking to use in the text and drawings), marking up the drawing pages of a patent document with the elements found on the drawings and bookmarking them, marking up all elements found in the document into the bookmarks, bookmarking the elements and linking them to the drawing page(s) and/or drawing figure(s) they are used in, bookmarking elements and linking them to the specification (e.g., the page, the column/line, the position on an image), bookmarking the elements to claims where the element names are used, bookmarking the claims to elements used, etc. Highlighting, underlining, and other emphasis may also be added for each that may allow the user to selectively turn on/off the emphasis. In another example, a search summary may be provided that includes the search terms, the most relevant drawings, page numbers (col/line) of most relevant sections etc. and may also include bookmarking to the document.

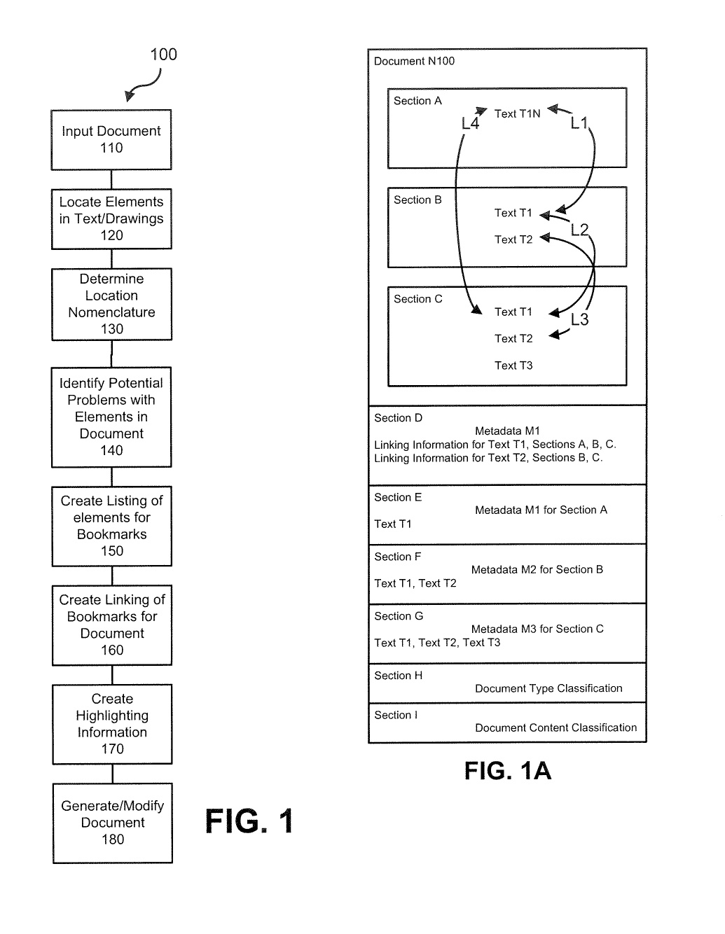

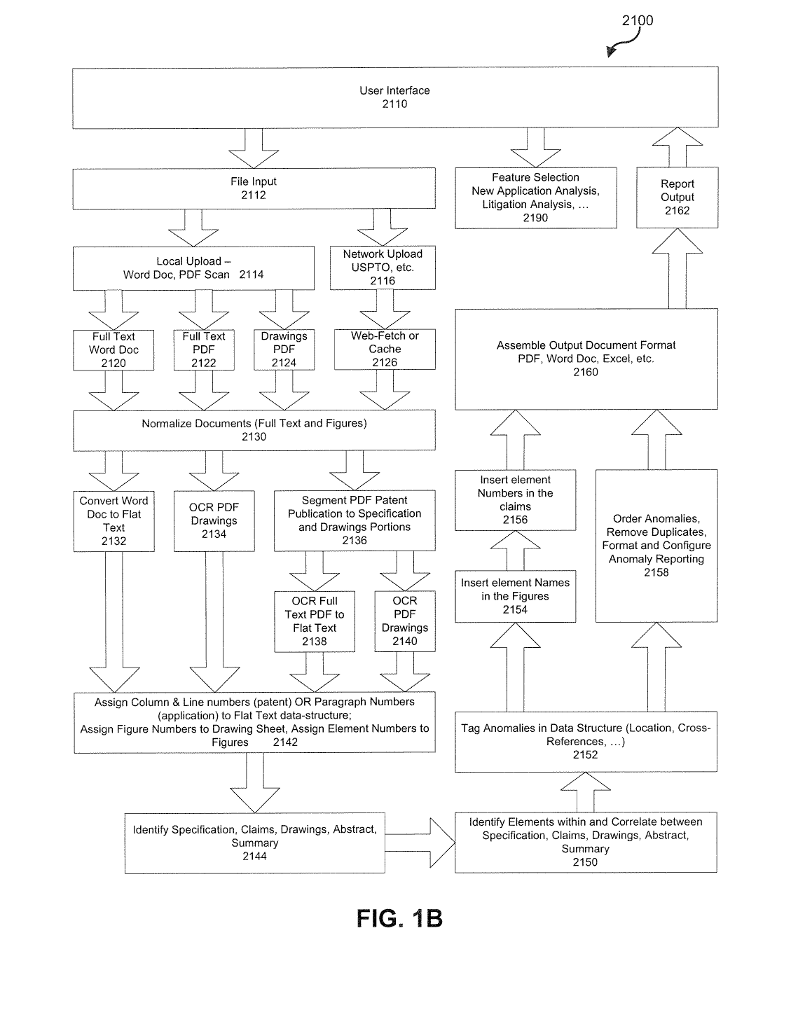

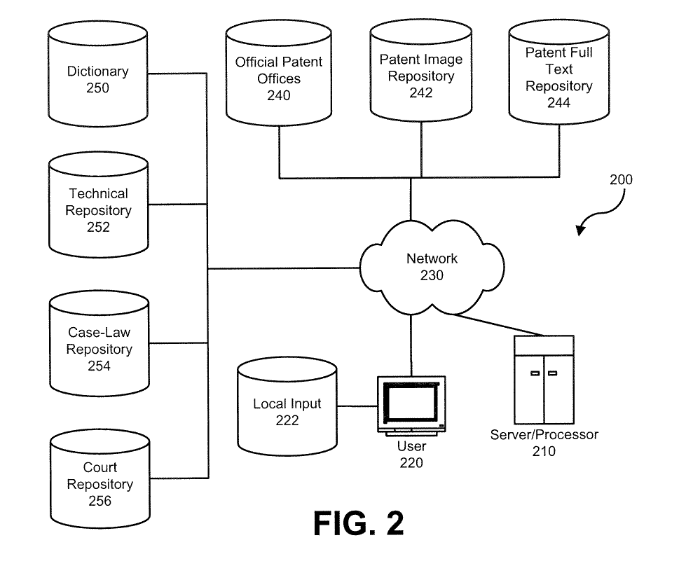

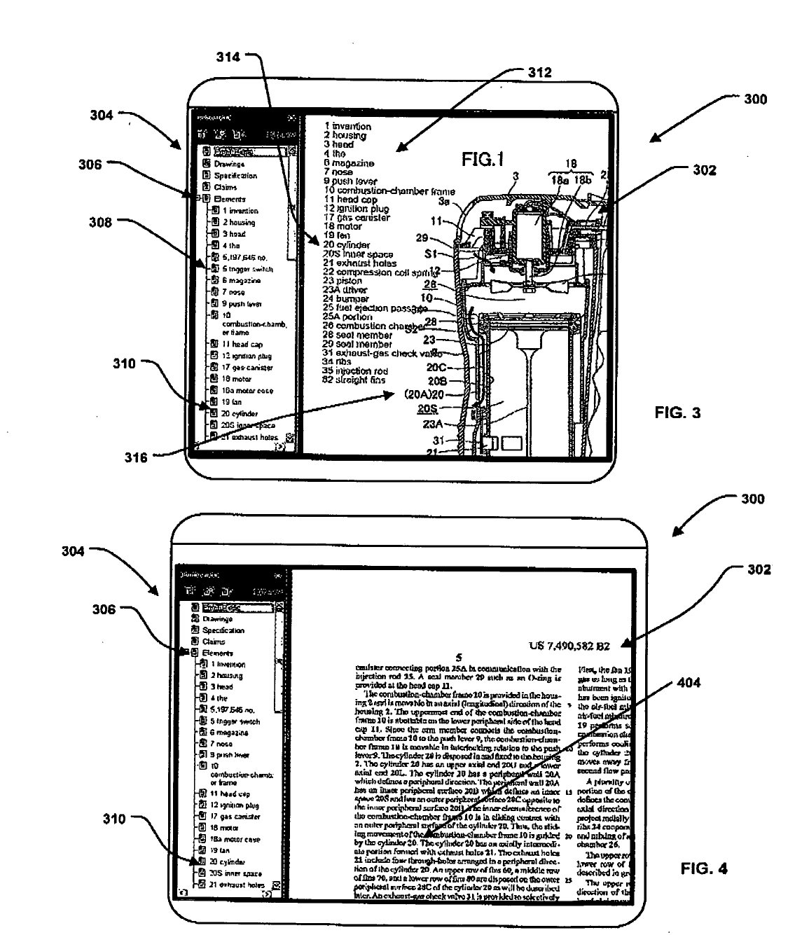

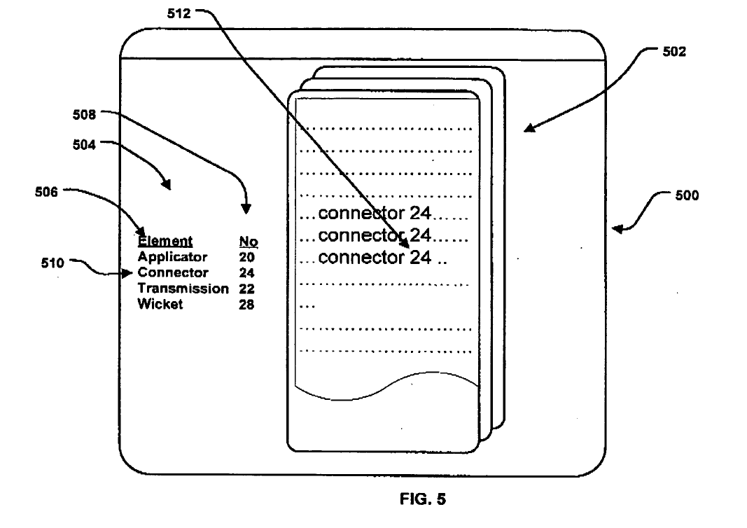

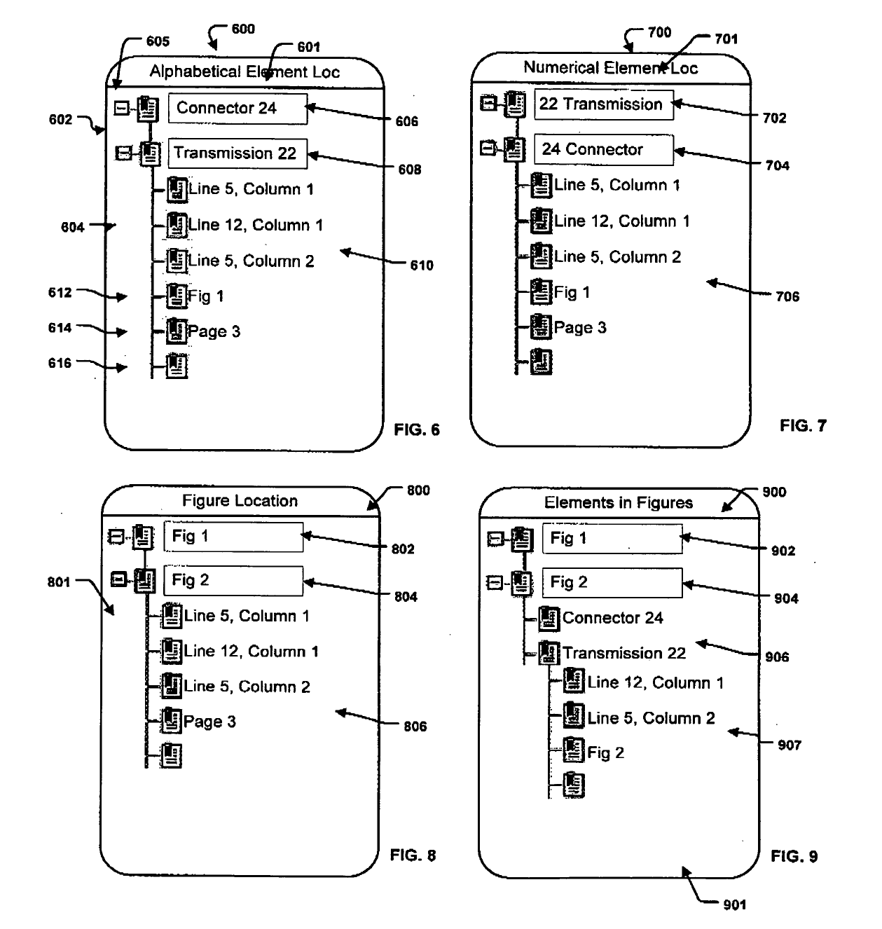

Referring now to FIG. 1, an example of a method for generating bookmarks and links within a document is shown. In general, the system may review a document for specific information, provide relations of that information to different sections of a document or the same section, determine the locations of that information, and provide a system allowing the user to easily view the information and optionally navigate to it in the document.

In step 110, a document is input that may include a single information source or multiple information sources. The document may be, for example, a patent document in PDF format, or other format, that may include images, text, or a combination of text and images. In an example, the document may be a PDF document that includes official patent office publications (as image data) and may also have text layered therein (e.g., for the dual-column format text and/or front page text). Alternatively, the document may include TIFF images (that may be separate or embedded in a PDF document). Alternatively, the document may include TIFF images (that may be separate or embedded in a PDF document) and also a text representation of the text embodied in the TIFF images (e.g., a text file described as flat text, XML or JSON, or equivalent format) that may be provided, for example, by an official Patent Office, or it may be determined based on OCR. Moreover, the document may be provided with text information and/or drawing descriptions based on OCR, segmentation, and/or blobbing of the drawings within the document for further analysis. In another example, the document may include a patent application, such as is typically filed in PDF form, or MS Word document form.

In step 120, the element names and numbers may be determined in the document. For example, the element names and numbers may be located by a variety of methods. For example, where a natural language processing (“NLP”) method is used, noun phrases having cardinal numbers (e.g., element numbers) after them may be determined to be elements. However, other methods may also be used, such as where letters are used out of place (e.g., would otherwise be syntactically correct such as “the piston P has an outer diameter”). The out of place letter may be determined to be an element number (the textual equivalent) and the phrase appearing before it may be determined to be the element name. Additional identification techniques may include identifying out of place formatting, such as primes (e.g., a single quote), double primes (e.g., a quote or two single quotes, depending on representation), subscript or superscript, as indicating an equivalent of an element number, and the text appearing before it may be the element name.

These elements may be identified from the general text of the document because they are noun phrases, for example. For example, an element of a patent document may be identified as a noun phrase, without the need for element number identification (as described below). In another example, elements may be identified by their being an Element Number (e.g., an alpha/numeric) present after a word, or a noun phrase. For example, an element of a patent document may be identified as a word having an alpha/numeric immediately after the word (e.g., “transmission 18”, “gear 19”, “pinion 20”).

User search terms, or other external information, may also be located and linked. For example, when the document is being reviewed based on a search, the user's search terms may also be identified and located in the document. Moreover, matching of search terms to the elements may provide for enhanced review of the document. For example, if a user inputs “connector” as a search term, the instances of “connector” may be located, and linked. Moreover, the user search term “connector” may be referenced against the element listing and may be found to be similar to “connector 10”. Thus, the search term “connector” may then be linked to a specific element, or group of elements (e.g., where there exist “connector 10” and “connector 12”) related to it. Further, the search term may be linked to the drawing pages and figures that may or may not contain the word “connector”. For example, if the drawing page includes the word “connector”, the search term may be linked to it. Also, if the drawing page includes the element “10”, then because the element name/number pair “connector 10” contains the search term “connector”, then it may be linked, and each location also linked. Moreover, the search terms may be broadened using stemming and/or synonyms or other methods to broaden out the potential for linking.

In step 140, potential problems with the elements may be identified in the document. For example, the document may be processed by a computer system for errors, to extract specific pieces of information, or to mark-up the document. Given any errors or potential errors located in the document, this information may be stored for further publication in the bookmarks as discussed below to provide to the user in a unified document. This information may be helpful when, for example, analyzing a document for potential problems or weaknesses.

For example, the text portion of the document may be analyzed to identify errors therein. The errors may be determined based on the type of document. For example, where a patent application is processed the claim terms may be checked against the detailed description. Graphical components may be referenced by or associated with text portions referencing such graphical portions of a figure (e.g., a figure of a patent drawing). Relevant portions of either the text or graphics may be extracted from the document and output in a form, report format, or placed back into the document as comments. The graphical components or text may be marked with relevant information such as element names or colorized to distinguish each graphical element from each other.

Upon identifying such relevant information, further analysis can be conducted relevant to the document or information contained therein. For example, based on information extracted from the document, analysis of other sources of information or other documents may be conducted to obtain additional information relating to the document. A report generation block may take the chunks, tokens, and analysis performed and constructs an organized report for the user that indicates errors, warnings, and other useful information (e.g., a parts list of element names and element numbers, an accounting of claims and claim types such as 3 independent claims and 20 total claims). The errors, warnings, and other information may be placed in a separate document or they may be added to the original document.

The patent or patent application may then be processed by a server/processor 210 (see FIG. 2) to extract information or identify errors. In one example, the drawings are reviewed for errors or associated with specification and claim information (described in detail below). In another example, the specification is reviewed for consistency of terms, proper language usage or other features as may be required by appropriate patent laws. In yet a further example, the claims are reviewed for antecedent basis or other errors. It will be readily understood by one skilled in the art that the patent or patent application may be reviewed for any known or foreseeable errors or any information may be extracted therefrom.

Server/processor 210 may then output an error/warning for the term and associated element number having the least number of occurrences, such as “incorrect element number.” For example, if the specification term “connector 12” is found in the specification three times and the term “connector 14” is found once, then for the term “connector 14”, an error will be output for the term “connector 14.” The error may also include helpful information to correct the error such as “connector 14 may mislabeled connector 12 that is first defined at page 9, line 9 of paragraph 9”.

In another example, server processor 210 looks to see whether the same element number is associated with different specification terms. If so, then one version may be correct while the other version is incorrect. Therefore, server/processor 210 determines which version of the specification term occurs more frequently in the specification. Then, server/processor 210 outputs an error for the term and associated element number having the least number of occurrences, such as “incorrect specification element.” For example, if the term “connector 12” is found in the specification three times and the term “carriage 12” is found once, then an appropriate error statement is output for the term “carriage 12.”

In another example, server/processor 210 looks to see whether proper antecedent basis is found for the specification terms. As stated previously, server/processor 210 records the determiners or words preceding the specification elements. Server/processor 210 reviews those words in order of their occurrence and determines whether proper antecedent basis exists based on the term's location in the specification. For example, the first occurrence of the term “connector 12” is reviewed to see if it includes the term “a” or “an.” If not, then an error statement is output for the term at that particular location. Likewise, subsequent occurrences of a specification term in the specification may be reviewed to ensure that the specification terms include the words “said” or “the.” If not, then an appropriate error response is output.

In another example, server/processor 210 reviews the claim terms for correct antecedent basis similar to that discussed above. As stated previously, server/processor 210 records the word before each claim term. Accordingly, the claim terms are reviewed to see that the first occurrence of the claim term in accordance with claim dependency (discussed previously herein) uses the appropriate words such as “a” or “an” and the subsequent occurrences in order of dependency include the appropriate terms such as “the” or “said.” If not, then an appropriate error response is output.

In another example, server/processor 210 reviews the specification terms against the claim terms to ensure that all claim terms are supported in the specification. More specifically, server/processor 210 records each specification term that has an element number. Server/processor 210 then determines whether any of the claim terms are not found among the set of recorded specification terms. If claim terms are found that are not in the specification, then server/processor 210 outputs an error message for that claim term accordingly. This error may then be used by the user to determine whether that term should be used in the specification or at least defined.

In another example, server/processor 210 identifies specification terms that should be numbered. Server/processor 210 identifies specification terms without element numbers that match any of the claim terms. Server/processor 220 outputs an error message for each unnumbered term accordingly. For example, server/processor 210 may iterate through the specification and match claim terms with the sequence of tokens. If a match is found with the series of tokens and no element number is used thereafter, server/processor 210 determines that an element is used without a reference numeral or other identifier (e.g., a symbol).

In another example, specification terms or claim terms having specific or important meaning are identified. Here, server/processor 210 reviews the specification and claims to determine whether words of specific meaning are used in the specification or claims. If so, then an error message is output. For example, if the words “must”, “required”, “always”, “critical”, “essential” or other similar words are used in the specification or claims, then a statement is output such as “limiting words are being used in the specification.” Likewise, if the terms “whereby” “means” or other types of words are used in the claims, then a statement describing the implications of such usage is output. Such implications and other such words will be readily understandable to one of skill in the art.

In another example, server/processor 210 looks for differing terms from specification and claim terms that, although different, are correct variations of such specification or claim terms. As stated previously, server/processor 210 records each specification term and claim term. Server/processor 210 compares each of the specification terms. Server/processor 210 also compares each of the claim terms. If server/processor 210 identifies variant forms of the same terms, then server/processor 210 outputs a statement indicating that the variant term may be the same as the main term. In one example, server/processor 210 compares each word of each term, starting from the end marker and working toward the beginning marker, to see if there is a match in such words or element numbers. If there is a match and the number of words between markers for the subsequently occurring term is shorter than its first occurrence, then a statement for the subsequently occurring term is output. For example, where the first occurrence in the specification of the term is “electrical connector 12” and a second occurrence in the specification of a term is “connector 12”, this second occurrence of the specification term “connector” is determined by server/processor 210 as one of the occurrences of the specification term “electrical connector 12.” Accordingly, for the term “connector 12”, server/processor 210 outputs “this is the same term as upper connector 12.” Other similar variations of terms that are consistent with Patent Office practice and procedure are also reviewed.

Where a specification or claim term includes two different modifiers and a subsequent term is truncated, then server/processor 210 outputs “clear to which prior term this term refers”. For example, where the terms “upper connector” and “lower connector” are used and a subsequent term “connector” is also used, then the process outputs an appropriate error response for the term “connector.”

In the instance where a term is not identified as a subset term, then in an example, it is output as a new term. For example, if the first occurrence of a specification term is “upper connector 12” and “lower connector 12”, then the term “upper connector 12” will be output. “Lower connector 12” will also be output as a different element at different locations in the specification.

It will be understood that the application is not limited to the specific responses as referenced above, and that any suitable output is contemplated in accordance with the invention including automatically making the appropriate correction. The errors and/or potential errors located as discussed above may be stored for further processing and use.

In step 150, a listing of the elements for bookmarking may be created from the document. For example, the listing may include the element name/number combinations and/or the listing may include claim elements, figure numbers, document sections, or other items of interest such as search terms. The listing may be stored as a general data structure in memory or stored to disk. Examples include XML format that can provide a structured element-by-element listing, as well as the location information, linking (discussed below), and any other desirable information or linking information within the document or other documents.

In step 160, linking of the bookmarks to the document may be performed, for example, for elements, figures, errors, and search terms. In general, items of interest may be identified as useful to the user of the document and these items may be placed within the document using bookmarking (discussed below).

Linking for the elements may include a listing of elements with an expandable view, such as a tree-view. This tree view may include bookmarks for each element's first use, as well as each use of the element within the document. This allows the user to navigate directly to where the element is in use.

Each figure may also be linked. When a drawing analysis is performed, rather than using “sheet number” information to identify the figure pages, each figure may be identified individually. For example, the linking of “page 4” of the document may be linked to “FIG. 6” and “FIG. 7”. As discussed below with respect to bookmarks, the linking and bookmarking allows for easy navigation through the document. Moreover, in an example of linking, the elements associated with “FIG. 6” may be associated with an element name, an element number, and each of the locations where they appear. Similarly, the element names and numbers may be linked with the figure number, the page the figure appears, etc.

Errors may also be linked. For example, when an element “connector 10” is identified, each instance of “connector 10” (and/or its variants) may be identified in the document, as well as “connector” and “10” separately, likely claim terms related to “connector 10”, errors or potential errors (e.g., inconsistencies such as “plug 10” rather than “connector 10”), that element number “10” does not appear in the drawings etc. Thus, the existence and location of the error may be linked to the elements, the drawings, etc. for later use.

User search terms or other external information, may also be located and linked. For example, when the document is being reviewed based on a search, the user's search terms may also be identified and located in the document. Moreover, matching of search terms to the elements may provide for enhanced review of the document. For example, if a user inputs “connector” as a search term, the instances of “connector” may be located, and linked. Moreover, the user search term “connector” may be referenced against the element listing and may be found to be similar to “connector 10”. Thus, the search term “connector” may then be linked to a specific element, or group of elements (e.g., where there exist “connector 10” and “connector 12”) related to it. Further, the search term may be linked to the drawing pages and figures that may or may not contain the word “connector”. For example, if the drawing page includes the word “connector”, the search term may be linked to it. Also, if the drawing page includes the element “10”, then because the element name/number pair “connector 10” contains the search term “connector” then it may be linked, and each location also linked. Moreover, the search terms may be broadened using stemming and/or synonyms or other methods to broaden out the potential for linking.

In general, the linking process allows for element names, element numbers, element name/number pairs, figures, figure pages, text pages, column/line numbering, claim terms, claims numbers, claim dependencies, etc. to be fully linked together. This linking may be driven by element name/number pairs or it may be driven by the text or figure information. However, when fully linked, each item of interest in the document is related to each other and their locations determined in the document. Using this information, bookmarking may be used to enhance the viewing experience of the document.

In step 170, highlighting, underlining, or other emphasizing may be created for the information related to the bookmarks. For example, the text for highlighting may be determined. In one example, this may include the element name/number pairs. In another example, this may include the element names. In another example, this may include the search terms. In another example, this may include the element numbers. In another example, this may include the errors, etc. In general, the emphasizing may include text for search/highlighting if using a rich viewer (e.g., PDF viewer) that can highlight text provided, or it may include the pixel-based location of where emphasizing should begin and end (or a box definition).

In step 180, the document may be generated or modified with the bookmarking and/or emphasizing. For example, where a PDF document is used, the document may be modified with the addition of bookmarks. This may be performed, for example, using a “stamper tool” such as is available from iText (a widespread PDF editing library) and others. Such a tool or its equivalent may be used to modify a patent PDF document to include the bookmarks for elements, figures, potential problems/errors, search terms, and figures. The tools may also be used to add other information, such as the element name/numbers to the drawings themselves for easy reference. Each piece of information for bookmarking may be identified in a data structure that includes the displayed text for the bookmark, a location (if any) when clicked will navigate the user to the location, and sub-bookmarks (in any number of sub-levels) that allow for additional locations, problems, figures, etc. to be identified and linked to a location within the document. Alternatively, the document including bookmarks may be a new document based on combined TIFF images, the bookmarking and linking added, and other information.

FIG. 1A is an example of document analysis for improved indexing, searching, and display. A document N100 includes, for example, three sections, Section A, Section B, and Section C. The document sections (A, B, C) may be determined from the Document Type Classification. In a patent document, Section A may include drawing images (and may further include subsections for each drawing page and drawing figure), Section B may include the detailed description (and may further include subsections for drawing figure references, paragraphs, tables, etc.), and Section C may include the claims (and may further include subsections for each independent claim, and dependent claims).

An information linking method may be performed on the Document N100 to provide links between text in each section (e.g., Sections A, B, C). Such linking information may be included in a generated metadata section, Section D, that contains linking information for the text within each of Sections A, B, C. In general, keywords or general text may be associated with each other between sections. In an example, Text T1 appearing in the claims Section C as a “transmission” may be associated by link L2 to an appearance of “transmission” in the detailed description Section B. In another example, the Text T1 appearing in the detailed description Section B as “transmission 10” may be linked L1 with a drawing figure in Section A where element number “10” appears. In another example, the Text T1 appearing in the claims Section C as “transmission” may be linked L4 with a drawing figure in Section A by the appearance of element number “10”, the relation of element name “transmission” and element number “10” provided by the detailed description. In another example, Text T2 appearing in the claims Section C as a “bearing” may be associated by link L3 to an appearance of “bearing” in the detailed description Section B.

Another generated metadata section, Section E, may include additional information on Section A. For example, where Section A is a graphical object or set of objects, such as drawing figures, Section E may include keyword text that relates to section A. In an example where Section A is a drawing figure that includes the element number “10” as Text T1N, relational information from the detailed description Section B, may be used to relate the element name “transmission” (defined in the detailed description as “transmission 10”) with element number “10” in Section A. Thus, an example of metadata generated from the Document N100 may include Section E, including the words “transmission” and/or “10”. Further, the metadata may be tagged to show that the element number is “10” and the associated element name is “transmission”. Alternatively, Section E could include straight text, such as “transmission”, “transmission 10”, and/or “10”, to be indexed or further used in searching methods. Such metadata may be used in the search or index field to allow for identification of the drawing figure when a search term is input. For example, if the search term is “transmission”, Section E may be used to determine that “FIG. 1” or “FIG. 2”, of Document N100, is relevant to the search (e.g., for weighting using document sections to enhance relevancy ranking of the results) or display (e.g., showing the user the most relevant drawing in a results output).

Another generated metadata section, Section F, may include metadata for Section B. In an example, Section B may be assigned to the detailed description section of a patent document. Section F may include element names and element numbers, and their mapping. For example, Text T1 may be included as “transmission 10” and text T2 may include “bearing 20”. Moreover, the mapping may be included that maps “transmission” to “10” and “bearing” to “20”. Such mapping allows for the linking methods (e.g., as described above with respect to Text T1 in section B “transmission” with Text T1N “10” in section A). Section F may be utilized in a search method to provide enhanced relevancy, enhanced results display, and enhanced document display. For example, in determining relevancy, when a search term is “transmission”, Section F allows the search method to boost the relevancy for the term with respect to Document N100 for that term because the term is used as an element name in the document. This fact that the search term is an element may indicate enhanced relevancy because it is discussed in particularity for that particular document. Additionally, the information may enhance the results display because the mapping to a drawing figure allows for the most relevant drawing figure to be displayed in the result. An enhanced document display (e.g., when drilling down into the document from a results display) allows for linking of the search term with the document sections. This allows for the display to adapt to the user request, for example clicking on the term in the document display may show the user the relevant drawing or claim (e.g., from Sections A, C).

Another generated metadata section, Section G, may include metadata for the claims section of Document N100. Each claim term may be included for more particularized searching and with linking information to the figures in Section A. For example, where claim 1 includes the word “transmission”, it may be included in Section G as a claim term, and further linked to the specification sections in Section B that use the term, as well as the figures in Section A that relate to “transmission” (linking provided by the detailed description or by element numbers inserted into the claims).

Another generated metadata section, Section H, may include Document Type Classification information for Document N100. In this example, the Document Type may be determined to be a patent document. This may be embodied as a code to straight text to indicate the document type.

Another generated metadata section, Section I, may include Document Content Classification information for Document N100. In this example, the document class may be determined as being the “transmission” arts, and may be assigned a class/subclass (as determined b the United States Patent and Trademark Office). Moreover, each section of Document N100 may be classified as to content. For example, Section C includes patent claims that may be classified. In another example, the detailed description Section B may be classified. In another example, each drawing page and/or drawing figure may be classified in Section A. Such classification may be considered document sub-classification, which allows for more particularized indexing and searching.

It is also contemplated that the metadata may be stored as a file separate from Document N100, added to Document N100, or maintained in a disparate manner or in a database that relates the information to Document N100. Moreover, each section may include subsections. For example, Section A may include subsections for each drawing page or drawing figure, each having metadata section(s). In another example, Section C may include subsections, each subsection having metadata sections, for example, linking dependent claims to independent claims, claim terms or words with each claim, and each claim term to the figures and detailed description sections. Classification by document section and subsection allows for increased search relevancy.

When using the metadata for Document N100, an indexing method or search method may provide for enhanced relevancy determination. For example, where each drawing figure is classified (e.g., by using element names gleaned from the specification by element number), a search may allow for a single-figure relevancy determination rather than entire document relevancy determination. Using a search method providing for particularized searching, the relevancy of a document including all of the search terms in a single drawing may be more relevant than a document containing all of the search terms sporadically placed throughout the document (e.g., one search term in the background, one search term in the detailed description, and one search term in the claims).

FIG. 1B is a functional flow diagram 2100 of a document analysis system for use with the methods and systems described herein. In general, flow diagram 2100 provides a basis for analyzing numerous types of documents that may include, for example, issued patents, published patent applications, and unpublished patent applications. For example, block 2160 may be used to assemble a patent PDF document that includes markups for element names/numbers in the drawings, as well as bookmarking for element, errors, and other useful information.

Block 2110 described a user interface that may be a network interface (e.g., for use over a network such as the Internet) or a local program interface (e.g., a program that operates on the Windows® operating system). User 220 may use a feature selection process 2190 to identify to the system what type of analysis is requested (e.g., application filing, litigation, etc.) for the particular documents identified (e.g., new patent application, published application, issued patent). In block 2112, the user inputs files or document identifiers. Local upload block 2114 allows user 220 to provide the files directly to the system, for example through an HTTPS interface from a local computer or a local network. When user 220 identifies a file, rather than uploading it directly, the system will search out the file to download through a network upload protocol 2116. In an example where user 220 identifies a patent or a published patent application, the system will locate the appropriate files from a repository (e.g., the USPTO). In block 2126, the system will fetch the files via the network or may also load the files from a cache (e.g., a local disk or networked repository).

In blocks 2120, 2122, 2124 the full text (e.g., a Word® document) is uploaded, a PDF file is uploaded, and PDF drawings are uploaded. It is understood that other document forms may be utilized other than those specified herein.

In step 2130, the files are normalized to a standard format for processing. For example, a Word® document may be converted to flat-text, the PDF files may be OCRed to provide flat text, etc., as shown by blocks 2132, 2134. In block 2136, document types such as a patent publication etc., may be segmented into different portions so that the full-text portion may be OCRed (as in step 2138) and the drawings may be OCRed (as in step 2140) using different methods tailored to the particular nature of each section. For example, the drawings may use a text/graphics separation method to identify figure numbers and element numbers in the drawings that would otherwise confuse a standard OCR method.

For example, the text/graphics is provided by an OCR system that is optimized to detect numbers, words and/or letters in a cluttered image space, such as, for example, that entitled “Text/Graphics Separation Revisited” by Karl Tombre et al. located at “http://www.loria.fr/˜tombre/tombre-das02.pdf”, the entirety of which is hereby incorporated by reference. In another example, separation of textual parts from graphical parts in a binarized image is shown and described at “http://www.qgar.org/static.php?demoName=QAtextGraphicsSeparation&demoTitre=Text/graphics %20separation”.

In block 2142, location identifiers may be added as metadata to the normalized files. In an example of an issued patent, the column and line numbers may be added as metadata to the OCR text. In another example, the location of element numbers and figure numbers may be assigned to the figures. It is understood that the location of the information contained in the documents may also be added directly in the OCR method, for example, or at other points in the method.

In block 2144, the portions of the documents analyzed are identified. In the example of a patent document, the specification, claims, drawings, abstract, and summary may be identified and metadata added to identify them.

In block 2150, the elements and element numbers may be identified within the document and may be related between different sections. In the example of a patent document, the element numbers in the specification are related to the element names in the specification and claims. Additionally, the element names may be related to the element numbers in the figures. Also, the figure numbers in the drawings may be related to the figure numbers in the specification. Such relations may be performed for each related term in the document, and for each section in the document.

In block 2152, any anomalies within each section and between sections may be tagged for future reporting to user 220. For example, the anomaly may be tagged in metadata with an anomaly type (e.g., inconsistent element name, inconsistent element number, wrong figure referenced, element number not referenced in the figure, etc.) and also the location of the anomaly in the document (e.g., paragraph number, column, line number, etc.). Moreover, cross-references to the appropriate usage may also be included in metadata (e.g., the first defined element name that would correlate with the anomaly).

Additional processing may occur when, for example, the user selects to have element names identified in the figures and/or element numbers identified in the claims. In block 2154, the element names are inserted or overlaid into the figures. For example, where each element number appears in the figures, the element name is placed near the element number in the figures. Alternatively, the element numbers and names may be added in a table, for example, on the side of the drawing page in which they appear. In block 2156, the element numbers may be added to the claims to simplify the lookup process for user 220 or to format the claims for foreign practice. For example, where the claim reads “said engine is connected to said transmission” the process may insert the claim numbers as “said engine (10) is connected to said transmission (12)”.

When processing is complete, the system may assemble the output (e.g., a reporting of the process findings) for the user which may be in the format of a Word® document, an Excel® spreadsheet, a PDF file, an HTML-based filed, etc.

At block 2162, the output is sent to user 220, for example via e-mail or a secure web-page, etc.

In another example, the system recognizes closed portion of the figures and/or differentiates cross-hatching or shading of each of the figures. In doing so, the system may assign a particular color to the closed portion or the particular cross-hatched elements. Thus, the user is presented with a color-identified figure for easier viewing of the elements.

In another example, the user may wish to identify particular element names, element numbers, and/or figure portions throughout the entire document. When user 220 identifies an element number of interest, the system shows each occurrence of the element number, each occurrence of the element name associated with the element number, each occurrence of the element in the claims, summary, and abstract, and the element as used in the figures. Moreover, the system may also highlight variants of the element name as used in the specification, for example, in a slightly different shade than is used for the other highlights (where color highlighting is used).

In another example, the system may recognize cross-hatching patterns and colorizes the figures based on the cross-hatching patterns and/or closed regions in the figures. Closed regions in the figures are those that are closed by a line and are not open to the background region of the document. Thus, where an element number (with a leader line or an arrow) points to a closed region the system interprets this as an element. Similarly, cross-hatches of matching patterns may be colorized with the same colors. Cross-hatches of different patterns may be colorized in different colors to distinguish them from each other.

In another example, the system may highlight portions of the figures when the user moves a cursor over an element name or element number. Such highlighting may also be performed, for example, when the user is presented with an input box. The user may then input, for example, a “12” or an “engine”. The system then highlights each occurrence in the document including the specification and drawings. Alternatively, the system highlights a drawing portion that the user has moved the cursor over. Additionally, the system determines the element number associated with the highlighted drawing portion and also highlights each of the element numbers, element names, claim terms, etc. that are associate with that highlighted drawing portion.

In another example, an interactive patent file may be configured based on document analysis and text/graphical analysis of the drawings. For example, an interactive graphical document may be presented to the user that initially appears as a standard graphical-based PDF. However, the user may select and copy text that has been overlaid onto the document by using OCR methods as well as reconciling a full-text version of the document (if available). Moreover, on the copy operation the user may also receive the column and line number citation for the selection (which may assist user 220 in preparing, for example, a response to an office action). When the user pastes the selected text into another document, the copied text appears in quotations along with the column/line number, and if desired, the patent's first inventor to identify the reference (e.g., “text” (inventor; col. N, lines N-N)).

In another example, the user may request an enhanced patent document, fore example, in the form of an interactive PDF file. The enhanced patent document may appear at first instance as a typical PDF patent document. Additional functionality, e.g. the enhancements, allow the user to select text out of the document (using the select tool) and copy it. The user may also be provided with a tip (e.g., a bubble over the cursor) that gives then column and line number. Additionally, the user may select or otherwise identify a claim element or a specification element (e.g., by using a double-click) that will highlight and identify other instances in the document (e.g., claims, specification, and drawings).

Referring now to FIG. 2, an example of a system for information analysis 200 includes a server/processor 210 and a user 220. A network 230 generally provides a medium for information interchange between any number of components, including server/processor 210 and user 220. As discussed herein, network 230 may include a single network or any number of networks providing connectivity to certain components (e.g. a wired, wireless, optical network that may include in part the Internet). Alternatively, network 230 is not a necessary component and may be omitted where more than one component is part of a single computing unit. In an example, network 230 may not be required where the system and methods described herein are part of a stand-alone system.

Local inputs 222 may be used by user 220 to provide inputs, e.g. files such as Microsoft Word® documents, PDF documents, TIFF files etc. to the system. Processor 210 then takes the files input by user 220, analyzes/processes them, and sends a report back to user 220. The user may use a secure communication path to server/processor 210 such as “HTTPS” (a common network encryption/authentication system) or other encrypted communication protocols to avoid the possibility of privileged documents being intercepted. In general, upload to processor 210 may include a web-based interface that allows the user to select local files, input patent numbers or published application numbers, a docket number (e.g., for bill tracking), and other information. Delivery of analyzed files may be performed by processor 210 by sending the user an e-mail or the user may log-in using a web interface that allows the user to download the files.

In the example of a patent document, each document sent by user 220 is kept in secrecy and is not viewed, or viewable, by a human. All files are analyzed by machine and files sent from user 220 and any temporary files are on-the-fly encrypted when received and stored only temporarily during the analyzing process. Then analysis is complete and reports are sent to user 220 and any temporary files are permanently erased. Such encryption algorithms are readily available. An example of an encryption system is TrueCrypt available at “http://www.truecrypt.org/”. Any intermediate results or temporary files are also encrypted on-the-fly so that there is no possibility of human readable materials being readable, even temporarily. Such safeguards are used, for example, to avoid the possibility of disclosure. In an example of preserving foreign patent rights, a patent application should be kept confidential or under the provisions of a confidentiality agreement to prevent disclosure before filing.

Other information repositories may also be used by processor 210 such as when the user requests analysis of a published application or patent. In such cases, server processor 210 may receive an identifier, such as a patent number or published application number, and queries other information repositories to get the information. For example, an official patent source 240 (e.g., the United States Patent and Trademark Office, foreign patent offices such as the European Patent Office or Japanese Patent Office, WIPO, Esp@cenet, or other public or private patent offices or repositories) may be queried for relevant information. Other private sources may also be used that may include a patent image repository 242 and/or a patent full-text repository 244. In general, patent repositories 240, 242, 244 may be any storage facility or device for storing or maintaining text, drawing, patent family information (e.g. continuity data), or other information.

If the user requests secondary information being brought to bear on the analysis, other repositories may also be queried to provide data. Examples of secondary repositories may include a dictionary 250, a technical repository 252, a case-law repository 254, and a court repository 256. Other information repositories may be simply added and queried depending upon the type of information analyzed or if other sources of information become available. In the example where dictionary 250 is utilized, claim language may be compared against words contained in dictionary 250 to determine whether the words exist and/or whether they are common words. Technical repository 252 may be used to determine if certain words are terms of art, if for example the words are not found in a dictionary. To determine if claim terms have been litigated, construed by a District Court (or a particular District Court Judge), and whether the Federal Circuit or other appellate court has weighed in on claim construction, case-law repository 254 may be queried. In other cases, for example when the user requests a litigation report, court repository 256 may be queried to determine if the patent identified by the user is currently in litigation.

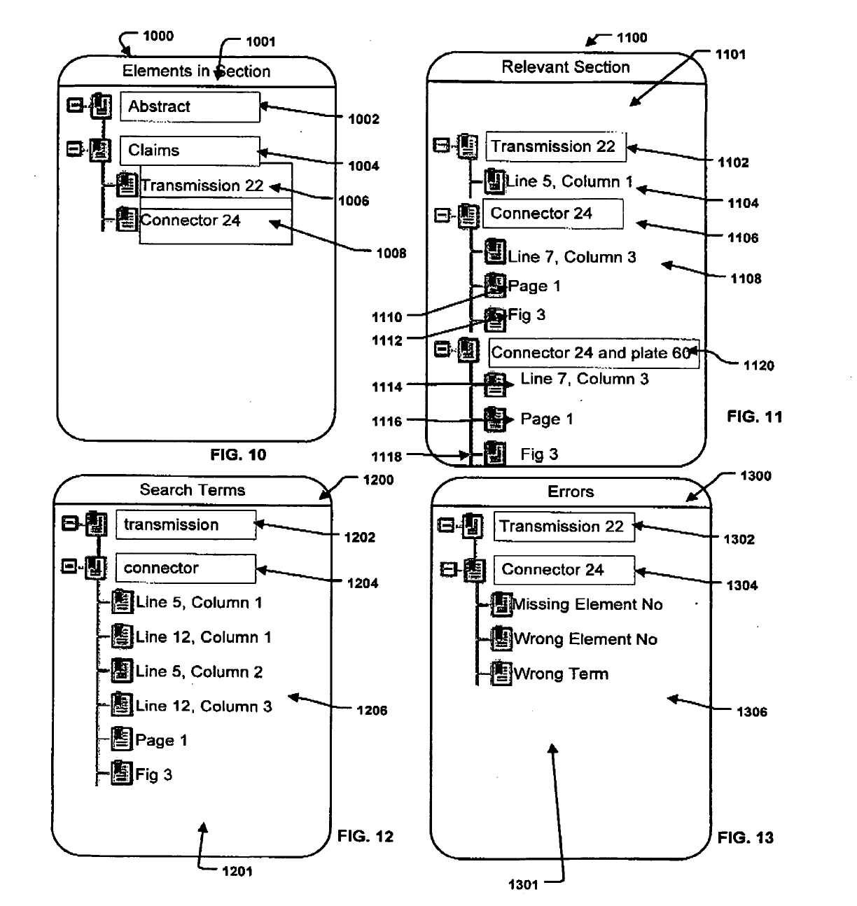

Referring now to FIG. 3, an embodiment of the invention is shown and described. In FIG. 3, a display 300 is shown that includes a document portion 302 and an index 304. In one example, the document portion 302 and index portion 304 are components of a PDF (portable document format) generated by software and algorithms of Adobe Systems®. However, the technology and documents described in the present application are not limited to the PDF format and can instead be of any document format.

In one example, the document portion 302 is a patent document. The portion of the document portion 302 shown by display 300 in FIG. 3 is a figure of a graphics portion of the patent document. In one example, the document portion 302 may be scrolled or otherwise moved in the display 300 to reveal other portions of the document portion 302 such as the specification, claims, abstract and other portions. Alternatively, the entirety of the document portion 302 may be shown by display 300.

In the example shown in FIG. 3, the document portion 302 is shown as including an element listing 312. The element listing 312 is a listing of elements found in the figure or drawing page of the document portion 302. Thus, for example, the element “20 cylinder” found in the element listing 314 corresponds to the number 316, corresponding to element number “20” found in the document portion 302. The element listing 312 may comprise only the elements used in the figure or drawing page or may be a complete listing of all the elements used in the text portion (as will be described) in the document portion 302.

The index 304 includes a plurality of links as represented by the words and numbers listed in the index 304. For example, the links in index 304 may correspond to sections in the patent application such as front page, drawings, specification or claims as shown. Alternatively, the links in the index 304 may correspond to figure numbers or elements as represented by link 306 entitled “elements.” The process or methods for identifying the links in the index 304 and generating the index 304 may include that which is described in the present application or in any of the patents or applications incorporated herein by reference or by the processes as provided by Adobe Systems®.

The index 304 may be, in one example, moved or scrolled or fixed independent of the document portion 302, or alternatively may be linked to the document portion 302 such that both the index 304 and the document portion 302 may be moved or scrolled as one. One skilled in the art will realize that many different links may be provided by the index 304 beyond that described in the present patent application.

The links in Index 304 may include sub links. For example link 306 includes sub links 308 that provide a sub listing of links that fall under the general category for which the link is provided. For example, the sub links 308 correspond to elements in the patent or patent application and therefore appropriately fall under the link 306 entitled “elements.” Likewise, there may also be sub links that fall under each of the sub links 306, and in such a relationship, sub links 306 may be referred to as links 306.

In one example, each of the links in the index 304 links to various portions of the document portion 302 through their sub links or through the links themselves. In one example, selection of a link by a user in the index 304 causes the document portion 302 to be scrolled by the display portion 300 to a location that identifies or brings the information represented by the link into view. For example, selection of the front page, drawings, specification or claim section causes the document 302 to be scrolled to a position identifying such sections or otherwise identifying such sections. In another example, such as for a non-PDF document or a PDF document with highlighting capabilities, selection of a link may cause an interactive response by the document portion 302 to identify or highlight words, terms, elements or other features associated with the link.

In one example, selection of a sub link 308 causes the display portion 300 to cause the document portion 302 to be moved, scrolled or to highlight the selected element in the document portion 302. In one example, as shown in FIG. 3, selection of the link 310 that is represented by “20 cylinder” causes the document portion 302 to be scrolled such that it identifies element number 314 in the element listing 312 or the element number 316 that is the element number for the element “20 cylinder.” Such selection may also cause the element number 314 or element number 316 to be highlighted. Such linking or highlighting may be accomplished through available linking programs and highlighting programs provided by Adobe Systems® or other known means.

Referring to FIG. 4, display 300 displays text of the document portion 302. The text of document portion 302 includes element 404 that recites “cylinder 20.” Similar to that described with respect to FIG. 3, selection of the link 310 in index 304 causes of the display portion 300 to position or otherwise identify element 404 in document 302 through a scrolling and positioning document portion 302, highlighting the element “cylinder 20”, or both. In one example, selection of the link 310 causes the element “cylinder 20” to be highlighted throughout the document portion 302 whether in the text portion or the graphical portion. In another embodiment, each time the link 310 is selected, display 300 moves the document portion 302 to the next occurrence of the element. It will be understood that the selection of the link 310 may cause the element “cylinder 20”, “cylinder”, or “20” to be scrolled into view or highlighted.

It will be understood that for purposes of the present application, the use of the term element as well as its description in element listing 314, index 304, or anywhere else in the graphical portion or text portion of the document portion 302 may or may not include both the element name and element number. For example, the link 310 or element 314 may include “20”, “cylinder”, “20 cylinder” or “cylinder 20.”

Referring now to FIG. 5, another embodiment according to the present invention is shown and described. In FIG. 5, a document portion 502 is shown in connection with an Index 504. The document portion 502 is shown including text such as “connector 24” and in one embodiment represents a text sections such as that associated with the document portion 302 of FIG. 4. It will also be understood that the document portion 502 includes a graphical portion such as that associated with the document portion 302 in FIG. 3. Similar to previously described embodiments, document portion 502 may be scrolled to various parts or may display the entirety of the document itself. In one example, document portion 502 is a patent or patent application.

The Index 504 includes an element name listing 506 and an element number listening 508. It will also be understood that the element name listing 506 and element number listing 508 may include sub links as will otherwise be described in this patent application. The element name listing 506 includes names of elements that may be found throughout the document portion 502. The element number listing 508 includes element numbers that may be found throughout the document portion 502. In the example, the Index 504 lists the element names in the element name listing 506 adjacent to the element numbers in the element number listing 508 to associate the names and their corresponding numbers. However, it will be understood that other means may be used to associate the element names and element numbers. In an example, the element numbers directly across from the element names in the Index 504 correspond to each other. For example, the listing 510 includes the element name “connector” under element listing 506 and the element number “24” under the element number listing 508. In one example, selection of an element under the element name listing 506 or the element number listing 508 causes that element to be identified in the document portion 502 through highlighting, scrolling the document portion 502 or other known means.

Referring now to FIG. 6, another embodiment of the invention is shown and described. In FIG. 6, a display 600 is shown with an index 601. It will be understood that Index 601 or any other index described with respect to any other embodiment or figure in the present application may be of any format as previously described are otherwise known in the art such as, for example, that described with document portion 302 or document portion 502 in FIGS. 3-5. Other displays and formats are also contemplated by the present application In the example FIG. 6, index 601 is in the format of PDF bookmarks as provided by Adobe Systems®. For non-limiting explanation purposes, it will be understood that the Index 601 is provided in connection with a document such as document portion 302 as illustrated with respect to FIGS. 3 and 4.

Index 601 includes link 606 and link 608 that respectively correlate to elements “connector 24” and “transmission 22” in a patent application. In the example, link 606 and link 608 are listed alphabetically and not numerically. As such, the word “connector” is listed above the word “transmission” and the number “24” is listed above number “22”. Expansion tabs 605 are provided to allow sub links under link 606 and link 608 to be viewed or hidden.

In one example, sub links 610 under link 608 link to locations in the document portion 302 of where the element or word represented by the link 608 is located. Additionally but not necessarily, the sub links 610 recite the specific locations as to where the element represented by the link 608 is located in the corresponding document portion 302. For example, sub links 604 recite a column and line number of where the element represented by the link 608 is located. Sub links 612 provide a figure number in which the element is located. Sub links 614 provides a page number on which the element is located. Sub link 616 does not provide a recitation of where the element is located, but it will be understood that the sub link 616 causes the display portion of identify where in the document portion 302 link 608 is located by scrolling the document portion 302 or otherwise highlighting the element in the document portion 302.

FIG. 7 illustrates another example of the present invention. In FIG. 7, link 702 and link 704 recite the same elements as discussed with respect to FIG. 6. However, as will be understood by reviewing the figure, link 702 and link 704 are illustrated in numerical order and not alphabetical order. It will also be understood that any order other than that described herein is contemplated by the present invention. Sub links under link 704 provide links to locations in the document portion 302 as described in other embodiments.

FIG. 8 illustrates another example of the present invention. In FIG. 8, index 801 includes link 802 and link 804 that respectively link “FIG. 1” and “FIG. 2” to locations in the document portion 302 where such figures are used or referenced. The links 802 and 804 include sub links 806 that recite line and column numbers, page numbers or any other location that references or employs the respective figure. For example, “FIG. 1” is used or referenced at line 5, Column 1 in the document portion 302, and therefore link 804 is linked to that location in the document portion 302 through the respective sub link that recites this location. Selection of the sub link causes the document portion 302 to be moved into view or the respective figure to be identified in the document portion 302. Likewise, “FIG. 2” is also used on page 3, for example if that is a location in the graphical portion of document 302 where a drawing for “FIG. 2” is found or the word FIG. 2 is found, and therefore index 801 provides a link to that location for link 804.

FIG. 9 illustrates another example of the present invention. In FIG. 9, link 902 and link 904 are provided by the index 901. Link 902 represents the term “FIG. 1” while link 904 represents the term “FIG. 2”. Under each of the links 902 and 904 are provided sub links that represent elements used in connection with the figures represented by the links 902 and 904. For example, elements used either in FIG. 1 of a patent or patent application or used in connection with a text portion describing or otherwise referring to or falling under FIG. 1 are listed as sub links to link 902. For example, under link 904 is found sub links 906 that refer to “connector 24” and “transmission 22.” The sub links 906 representing the elements include additional sub links 907 that further link the sub links 906 to their locations in the document portion 302. Thus, sub links 907 are linked to the locations in the document portion 302 that uses the recited elements in connection with “FIG. 2.” For example, an additional sub link is provided where “transmission 22” is used at Column 12, Line 1. Likewise, “transmission 22” is further used in FIG. 2, which may be identified by the use of the number “22” near or proximate the word “figure” or fig or by any other means as described or incorporated herein. The additional sub links 907 may also include the page on which a link is used.

Referring now to FIG. 10, another aspect of the present invention is shown and described. In FIG. 10, index 1001 is shown including link 1002 and a link 1004 that respectively recite “abstract” and “claims.” The terms “abstract” and “claims” refer to those sections of a patent document of document portion 302. It will be understood that the links 1002 and 1004 may include other sections beyond those mentioned and there may be more or less than two links contemplated by the present invention. In one example, sub links 1006 and 1008 are provided for the term “claims” that recites the elements “transmission 22” and “connector 24” found in the section entitled “claims.” The sub links may also be recited with or without the corresponding element number such that the recitation may instead be “transmission” or “connector” or “22” or “24.” Such alteration may be true for any embodiment described herein.

Accordingly, in the embodiment of FIG. 10, the sub links 1006 and 1008 respectively link to the portions within the section “claims” of document portion 302 in which the elements “transmission 22” and “connector 24” are found.

Referring now to FIG. 11, another embodiment of the present invention is shown and described. In FIG. 11, display 1100 includes index 1101 that provides links to the most relevant section, figure or drawing page for particular elements or terms. Index 1101 includes link 1102 that represents the element “transmission 22”, link 1106 that represents the element “connector 24” and link 1120 that represents a combination of the elements as shown therein. Accordingly, the most relevant location in the document portion 302 for the element represented by link 1102 is identified through sub link 1104. The most relevant section for the element represented by link 1106 is provided through sub links 1108, 1110, and 1112. The most relevant sections for link 1120, representing a combination of elements “plate 60” and “connector 24” is identified through sub links 1114, 1116 and 1118.

Referring now to FIG. 12, another embodiment of the present invention is shown and described. In FIG. 12, search terms are received by a search engine. Index 1201 lists the search terms as links 1202 and 1204. The links may be expanded or contracted to show sub links that link to the location of the search terms in the document portion 302. For example, link 1202 includes sub links 1204 that link to the location of the search terms in the document portion 302.

Referring now to FIG. 13, another embodiment of the present invention is shown and described. In FIG. 13, a display 1300 displays an index 1301. Index 1301 includes links 1302 and 1304 that identify a particular set of elements in the document portion 302. Each of the links 1302 and 1304 may be expanded or contracted to reveal sub links that identify particular errors associated with the elements. In the example shown in FIG. 13, sub links 1306 link to locations in the document portion 302 where particular errors may be found that are associated with the element “connector 24.” For example, the sub links 1306 include errors such as missing element number where the term “connector” is not found with an associated element number “24”, wrong element number such as where the term “connector” is found with an incorrect element number such as “22”, or no element number where the term “connector” is found with no element number. Other errors such as lack of support in the claims, the element not being found in any of the drawings or in the wrong drawing or other errors may also be identified through the index 1301 shown by the display 1300.

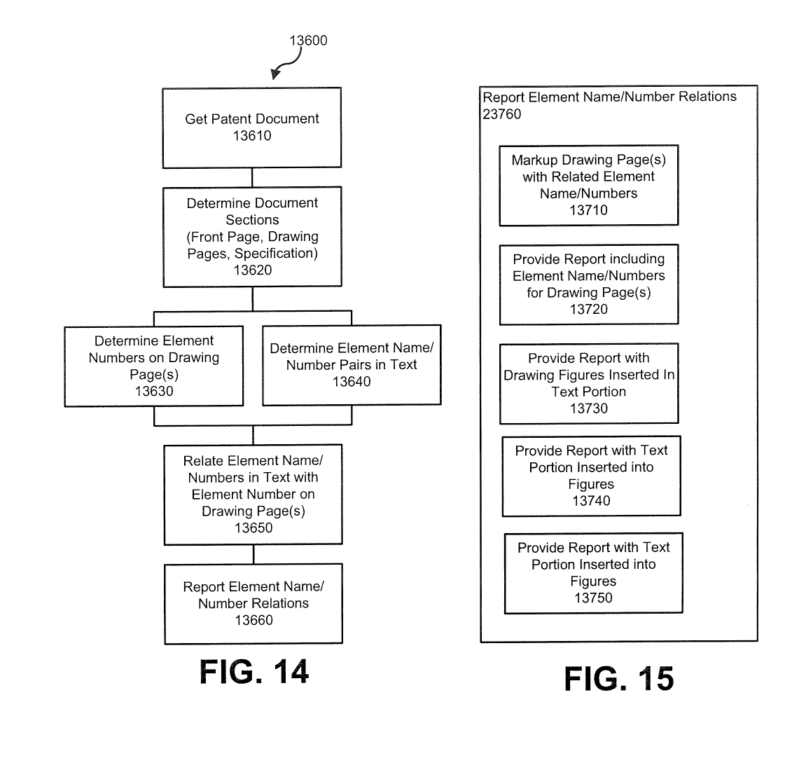

FIG. 14 is a flow diagram for a report generator related to patent documents.

In step 13610, a patent document may be identified and/or retrieved from a repository. The identification, for example, may be by a user inputting a document number, or for example, by a result from a search or other identifying method.

In step 13620, the document may be analyzed, for example, by determining document sections for the front page, drawing pages, and specification. Additional document sections may be identified from a graphical document, full text document, or mixed graphical (e.g., for the figures) and text for the text portion (e.g., the specification).

In step 13630, the element numbers may be determined for each drawing page and/or each figure on the drawing pages.

In step 13640, the element name/number pairs may be identified from the text portion of the document.

In step 13650, the element name/numbers from the text portion may be related to the element numbers found in the figures and drawing pages. The relation may also extend, for example, to the claims (for identifying potential element names/numbers in the specification and relating them to the claims), and relating to the summary, abstract, and drawings. Indeed, each of the drawing pages, drawing figures, detailed description, claims, abstract, summary, etc. may be related to each other.

In step 13660, a report may be generated and provided to the user having useful information about the relation of element names/numbers in the entire document. Examples of reports are described with respect to FIG. 27, among others, and additionally in the Related Patent Documents.

FIG. 15 is a flow diagram for a report generator related to patent documents, related to step 13660 of FIG. 14. Each of the steps described herein may be used independently or in combination with each other.

In step 13710, a report may be generated with the element names and numbers placed on each drawing page. This may assist the reader of the patent document with understanding the figures, and the entire document, more rapidly by allowing the reader to find the element names quickly, rather than having to search through the patent document. In an example, the element numbers from each drawing page may be determined, as discussed herein and as discussed in the Related Patent Documents. The element numbers may then be related to the text portion to determine the element name/numbers. The element name/numbers may then be added to the drawing page. In another example, the element name/numbers may be added to the drawing page near the figures, rather than the whole page. In another example, the element names may be added to the figures near the appearance of the element number in the figures to provide labeling in the figures, rather than a listing on the page. Alternatively, the element name/numbers may be added, for example, to the PDF document on the back side of each page. This may allow the reader to simply flip the page over to read it when printed. At the user's preference, this labeling scheme may be less intrusive if the user desires the original drawings to remain clean and unmarked.

In step 13720, an example of a report may include a separate page for the “parts list” of element name/numbers for the patent document. In another example, a report may be generated that includes the element names/numbers associated with each figure. This may include a header identifying the figure, and then a listing of the element name/numbers for that figure.

In step 13730, the report may include the figure inserted in the text portion. This may include reformatting the dual-column format of a standard patent document to a different format, and interstitially placing the appropriate figure in the text so that the reader need not refer to a separate drawing page. The insertion of the drawing figure may allow the reader to quickly understand the patent document by simply reading through the text portion, and referring to the figure directly from the text portion. The reformatted patent document may also include cites inserted for the original column number so that the reader may quickly orient themselves with the original dual-column format for column/line number citation.

Alternatively, a report may be generated for the claims portion that includes the claim and additional information. For example, a listing of drawing figures associated with each claim may be inserted. The relevant figures may be determined from the relation of claim terms with the figure's element names. The figure may also be inserted with the claims for quick reference. The figure may be scaled down, or full sized.

In step 13740, the report may include related portions of the text from the patent document inserted into the figure region. Where a figure is introduced in the specification, for example, that paragraph of text may be inserted into the drawing figure page, or on the back of the page, for quick reference.

In step 13750, the report may include a reformatted drawing page portion that includes the figure and additional information. For example, the additional information may include the associated element names/numbers, the column/line number and/or paragraph number where the figure is first introduced. It may also include the most relevant paragraph from the specification related to the figure. It may also include a listing of claims and/or claim terms related to the figure.

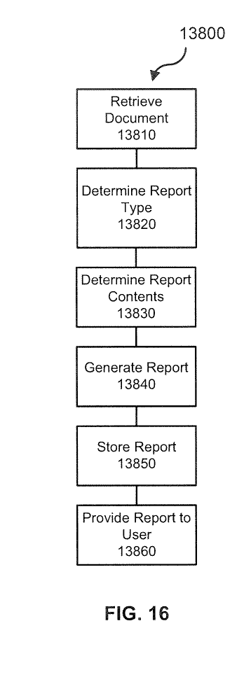

FIG. 16 is an example of a document retrieval and report generation method.

In step 13810, a document may be identified and/or retrieved from a repository. The identification may be by a user or by another method, e.g., a search result.

In step 13820, the report type is determined. For example, the user may specify a report type having marked up drawings, an element listing, a patent document having figures placed interstitially with the text, etc. Examples of various report types are described above with respect to FIG. 15.

In step 13830, the method may determine the contents of the report based on the report type chosen. For example, where the user chooses marked up drawings, the report contents may include a standard patent document with element names/numbers placed in the drawings.

In step 13840, the report may be generated by a system or method, as discussed herein and in the Related Patent Documents.

In step 13850, the report may be stored, for example, in memory and/or a disk.

In step 13860, the report may be provided to the user for download, viewing, or storage.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

Accordingly, it is to be understood that the above description is intended to be illustrative and not restrictive. Many embodiments and applications other than the examples provided will be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

We claim:

1. A computer implemented method for displaying document information, comprising:
receiving a document;
identifying a plurality of different terms in the document;
determining positions of the terms in the document; and
creating an index of the terms on the document, wherein the plurality of terms in the index are indexed to the plurality of positions in the document.

2. The computer implemented method according to claim 1, wherein:
the document includes graphics and text; and
at least some of the positions are in the graphics.

3. The computer implemented method according to claim 1, wherein at least one of the terms in the index is indexed to more than one position in the document.

4. The computer implemented method according to claim 1, wherein the term is identified in the patent document by highlighting or bookmarking the term in the patent document.

5. The computer implemented method according to claim 1, wherein the terms are specification terms.

6. The computer implemented method according to claim 5, wherein the specification terms include element numbers.

7. The computer implemented method according to claim 1, further comprising identifying the more than one position in the document simultaneously.

8. The computer implemented method according to claim 1, wherein:
the terms in the index further comprise elements of a patent or patent application; and
the positions are positions of the elements in the document.

9. The computer implemented method according to claim 1, wherein:
the terms in the index further comprise figures of a patent or patent application; and
the positions are positions of the figures in the document.

10. The computer implemented method according to claim 1, wherein:
the terms in the index further comprise figures of a patent or patent application; and
the positions are positions of the elements for each of the figures in the document.

11. The computer implemented method according to claim 1, wherein:
the terms in the index further comprise sections of a patent or patent application; and
the positions are positions of the elements in each of the sections of the document.

12. The computer implemented method according to claim 1, wherein the positions are most relevant sections of each of the terms in the document.

13. The computer implemented method according to claim 1, wherein:
the terms in the index further comprise errors of a patent or patent application; and
the positions are positions of the errors in the document.

14. The computer implemented method according to claim 1, wherein:
the terms in the index further comprise search terms received from a user input; and
the positions are positions of the search terms in the document.

15. A system for displaying document information, comprising:
a processor programmed to:
receive a document;
identify a plurality of different terms in the document;
determine positions of the terms in the document; and
create an index of the terms on the document, wherein the plurality of terms in the index are indexed to the plurality of positions in the document.

16. The system according to claim 15, wherein:
the terms in the index further comprise elements of a patent or patent application; and
the positions are positions of the elements in the document.

17. The system according to claim 15, wherein:
the terms in the index further comprise figures of a patent or patent application; and
the positions are positions of the figures in the document.

18. The system according to claim 15, wherein:
the terms in the index further comprise figures of a patent or patent application; and
the positions are positions of the elements for each of the figures in the document.

19. The system according to claim 15, wherein:
the terms in the index further comprise sections of a patent or patent application; and
the positions are positions of the elements in each of the sections of the document.

20. The system according to claim 15, wherein the positions are most relevant sections of each of the terms in the document.
